(19) United States
(12) Patent Application Publication
(10) Pub. No.: US 2024/0318724 A1
(43) Pub. Date: Sep. 26, 2024

(54) Flexible Structure

(71) Applicant: KSB SE & Co., KGaA, Frankenthal (DE)

(72) Inventors: Tammuz NOBEL, Frankenthal (DE); Joerg Alexander BOEHM, Frankenthal (DE)

(21) Appl. No.: 18/578,779

(22) PCT Filed: Jul. 4, 2022
(86) PCT No.: PCT/EP2022/068433

§ 371 Date: Jan. 12, 2024

(30) Foreign Application Priority Data
Jul. 15, 2021 (DE) 10 2021 118 381.2

(51) Int. Cl. F16J 15/3284; B33Y 80/00; F16J 15/44

(52) U.S. Cl. CPC F16J 15/3284; B33Y 80/00; F16J 15/445

(57) ABSTRACT

A structure includes elements. The elements are interconnected. The elements are also arranged movably relative to one another. The structure is arranged in a fluid in order to change the flow resistance.

### CROSS REFERENCE TO RELATED APPLICATION

This application claims priority under 35 U.S.C. § 119 from German Patent Application No. 102021118381.2, filed Jul. 15, 2021, the entire disclosure of which is herein expressly incorporated by reference.

### BACKGROUND

The disclosure relates to a structure with elements which are interconnected and are arranged movably relative to one another.

Such a structure with elements can perform the function of a mechanical seal, for example. A mechanical seal is a seal which, for example, seals a rotating pump shaft with respect to a fixed pump casing in such a way that the leakage loss is reduced to a minimum and any wear on the sealing surfaces is kept as small as possible. A mechanical seal is distinguished in having two surfaces that slide upon one another and are pressed against one another by axial forces. There is a liquid or gaseous lubricating film between the sliding surfaces.

Mechanical seals have a sealing gap, which is at right angles to the shaft axis. Shaft seals of this type are also referred to as axial or hydrodynamic mechanical seals. Such mechanical seals require less space and less maintenance than other seal systems. They perform well both at low and high pressures to be sealed and peripheral speeds.

In operation, two sealing surfaces slide upon one another and are pressed against one another by hydraulic and mechanical forces. Located between these two superfinished sliding surfaces is the sealing gap containing a lubricating film, which is usually liquid.

A mechanical seal in a centrifugal pump is used to seal a shaft passing through the casing. Mechanical seals are to be provided in various embodiments in centrifugal pumps, while the working range of the centrifugal pump should always be taken into account as regards the selection of materials.

DE 10 2018 208 574 A1 describes a shaft seal assembly having a mechanical seal and a secondary seal, which has at least one O-ring, which is arranged in an axially movable manner.

It is furthermore conceivable that a structure with elements may be used not only as a seal but also as a flow resistance in pipes. Flow resistance is the physical variable which relates in fluid dynamics to the force which opposes the fluid as a medium of a movement. A body which moves relative to a gaseous or liquid medium is subject to a flow resistance in the form of a force that acts counter to the relative speed.

Intentional flow resistances in pipes can be formed by fittings, for example. A fitting refers to a component for changing and controlling fluid flows which is used particularly in pipes. The choice of the type of fitting is subject to requirements in respect of tightness, restriction and direction of the fluid flow, and of the medium itself. Accordingly, a flow resistance which has an extremely high value corresponds almost to a seal.

DE 10 2020 003 756 A1 describes a fitting assembly comprising a casing with two openings and a channel which has a restrictor section, the cross section of which can be limited in a flexible manner. The restrictor section is designed as a flow resistance in a pipe.

The previously known solutions do not usually allow much static and dynamic variation. Influencing a fluid flow, right up to sealing, is not known in the context of known solutions of fittings and mechanical seals.

### SUMMARY

One object of the disclosure is to specify a structure for influencing fluid flows. Here, it should be possible to configure the structure in a tailored and customer-oriented way. Moreover, it should be possible to implement the structure simply, rapidly and inexpensively.

This and other objects are achieved according to the disclosure by a structure with elements. Preferred variants can be found in the description and the drawing.

According to the disclosure, the structure with elements is arranged in a fluid in order to change the flow resistance. Such an arrangement can preferably be used instead of a mechanical seal and/or as a variable flow resistance in a fluid flow.

One element is a basic component part of a structure and cannot be broken down further without losing its properties. According to the disclosure, the element can be embodied as a ring and/or link, as a sleeve and/or perforated plate and/or conical hollow body.

The elements advantageously have a connection to one another but are nevertheless arranged movably relative to one another. Such a connection is preferably made directly, e.g. as interwoven rings. An arrangement of elements which is connected in this way forms a sheet-like structure which is preferably formed into a funnel shape.

In another variant of the disclosure, the elements are connected indirectly by means of an auxiliary element and formed into a chain and/or assemblage and/or strand and/or row. Such an auxiliary element can be implemented as a strand-type, solid round material or as short loops. The elements, as individual links, form a band, which is preferably arranged in a spiral shape.

The connection between the elements is advantageously of flexible design, thus enabling the elements to move relative to one another. The flexible connection enables the arrangement of the elements relative to one another to be influenced in accordance with external forces, particularly in the form of movement. Ideally, the flow resistance formed by the structure with elements in fluids or fluid flows can be configured and set in a variable manner. Depending on the embodiment variant of the disclosure, the movement of the elements relative to one another can be implemented in at least one dimension, preferably in two dimensions, in particular in three dimensions.

According to the disclosure, the structure with elements is connected to a rotary drive. The connection is preferably made via a shaft. When the shaft is set in motion by the rotary drive, the structure with elements fans out on account of the movable arrangement and changes the flow resistance in a fluid flow.

Ideally, the connection between the structure with elements and the shaft is made by press-fitting and/or welding on or shrink-fitting on the shaft.

In a preferred variant of the disclosure, the structure with elements is embodied as a variable flow resistance in a pipe. The movement of the rotary drive and the embodiment of the elements lead to a flow resistance which can be adapted in a variable and rapid manner.

In another advantageous variant, the structure with elements forms a flow resistance on a pump shaft in a manner comparable to a mechanical seal. Depending on the shaft rotation, the amount of fluid flowing is just sufficient to lubricate the shaft.

Ideally, the structure with elements can have an increasing sealing effect when subject to the rotation of the shaft. This can be achieved, for example, by the configuration of the elements and by the fanning out of the structure when subject to rotation. In a particularly preferred variant of the disclosure, the structure with elements has a rubber lip. This rubber lip is preferably arranged at the outer periphery of the structure and preferably on the downstream side. With increasing rotation, the rubber lip can come into contact with a pipe wall or a shaft feedthrough and have a sealing effect. In an advantageous variant of the disclosure, the rubber lip can be replaced by a rubber cap which, given appropriate rotation, acts as a kind of cover, wherein the rubber cap comes into contact with a pipe wall or a shaft feedthrough and completely closes the flow cross section, thus ensuring that complete sealing is achieved.

Ideally, the structure with elements is of funnel-shaped design as a sheet-like formation. This configuration of the structure is particularly helpful to the fanning out of the funnel during rotation and thus to formation as a variable flow resistance. In an alternative variant of the disclosure, the elements of the structure are formed into a spiral, e.g. indirectly.

The structure with elements advantageously has cavities through which the fluid stream can flow. Depending on the configuration of the elements, the cavities are larger or smaller and can thus be configured to the required fluid flow.

According to the disclosure, the structure with elements is manufactured additively. Only on the basis of this special manufacturing technique is it possible to produce the structure in a flexible manner with an extremely low input of materials and very quickly. In particular, the connection of the elements to one another while simultaneously being arranged movably relative to one another can only be achieved by means of the additive manufacturing technique.

An additively manufactured structure is one that has been produced by an additive manufacturing method. The term “additive manufacturing methods” includes all manufacturing methods in which material is applied layer by layer and, in this way, three-dimensional elements are produced. In this case, the layer by layer buildup takes place under computer control from one or more liquid or solid materials according to predetermined dimensions and shapes. During the buildup, physical or chemical hardening or melting processes take place. Typical materials for 3D printing are plastics, synthetic resins, ceramics, metals, and carbon and graphite materials.

Generative or additive manufacturing methods are understood to mean methods in which material is applied layer by layer in order to produce a three-dimensional structure from elements. According to the disclosure, the variable flow resistance is designed as an additively manufactured structure. For the formation of the structure with elements, use is made, in particular, of selective laser melting and cladding, also known as deposition welding. In an alternative variant of the disclosure, extrusion in combination with the application of a meltable plastic is also a method that can be used.

In selective laser melting, one element of the structure is produced by a method in which a layer of a buildup material is first of all applied to a substrate. The buildup material for the production of the element of the structure preferably comprises metallic powder particles. In one variant of the disclosure, ferrous and/or cobalt-containing powder particles are used for this purpose. These can contain additives such as chromium, molybdenum or nickel. The metallic buildup material is applied in powder form in a thin layer to a plate. The powdered material is then fully melted locally at the respectively desired locations by means of radiation and, after hardening, a solid material layer is formed. The substrate is then lowered by the amount of a layer thickness and more powder is applied. This cycle is repeated until all the layers have been produced and the finished structure with elements has been formed. According to the disclosure, a structure is produced which is formed in a particularly intricate and optimized way as a flow resistance. The structure with elements cannot be produced industrially by conventional methods.

As radiation, it is possible, for example, to use a laser beam, which generates the element from the individual powder layers. The data for guiding the laser beam are generated by means of software on the basis of a 3D CAD body. Alternatively to selective laser melting, it is also possible to employ an electron beam (EBN).

During deposition welding or cladding, the element is produced by a method which coats an initial piece by welding. The deposition welding method uses a welding filler in the form of a wire or a powder to build up a volume which forms a particularly intricate and optimized shape of the element.

According to the disclosure, a structure with elements which are interconnected and are arranged movably relative to one another, is used in a fluid in order to change the flow resistance. The structure with elements is thus used as a flexible sealing structure, which is initially open for a fluid flow and can be converted by a rotary motion into a dynamic seal.

Further features and advantages of the disclosure will become apparent from the description of exemplary embodiments with reference to the drawings and from the drawings themselves.

In the drawings:

### BRIEF DESCRIPTION OF THE DRAWING

FIG. 1 shows a structure with elements in a pipe.

### DETAILED DESCRIPTION

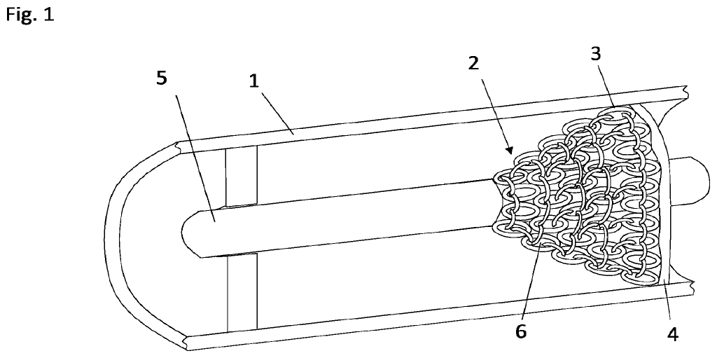

FIG. 1 shows, by way of example, a pipe 1, into which a structure 2 with elements 3 is inserted. In this embodiment variant, the structure 2 with elements 3 is embodied as a variable flow resistance, which is connected via a shaft 5 to a rotary drive. A fluid coming from the shaft side preferably flows across the variable flow resistance and/or through the cavities 6 in the variable flow resistance. The variable flow resistance is fanned out by the movement of the rotary drive, as a result of which the interconnected elements 3 drift apart in accordance with their connection on account of their mobility and on account of the effective centrifugal forces.

At the outer periphery of its structure 2, on the side away from the shaft, the variable flow resistance has a rubber lip 4, which, depending on the speed of rotation, can extend as far as the pipe 1 and have a sealing effect in the process. Thus, the variable flow resistance can also act as a seal at the maximum speed of rotation.

The variable flow resistance illustrated in FIG. 1 develops its resistance effect as the speed of rotation increases. The generatively manufactured elements 3 are connected movably to one another to form a funnel shape. The elements 3 can preferably be designed as rings, the material thickness of which is implemented as a function of the flow resistance to be formed.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1.-9. (canceled)

10. A structure comprising:
elements which are interconnected and are arranged movably relative to one another, wherein
the structure is arranged in a fluid in order to change the flow resistance.

11. The structure as claimed in claim 10, wherein the structure is connected to a rotary drive.

12. The structure as claimed in claim 11, wherein the structure has a sealing effect when subject to rotation.

13. The structure as claimed in claim 12, wherein the structure has a rubber lip.

14. The structure as claimed in claim 13, wherein the structure is of funnel-shaped design.

15. The structure as claimed in claim 13, wherein the structure is of spiral-shaped design.

16. The structure as claimed in claim 15, wherein the structure has cavities.

17. The structure as claimed in claim 16, wherein the structure is manufactured additively.

18. A method comprising:
using a structure with elements which are interconnected and are arranged movably relative to one another, in a fluid in order to change the flow resistance.
